(19) United States
(12) Patent Application Publication
(10) Pub. No.: US 2005/0060863 A1
(43) Pub. Date: Mar. 24, 2005

(54) Assembly process for scrapless clutch plate assembly

(75) Inventor: Paul D. Terpstra, Janesville, WI (US)

Correspondence Address: FOLEY & LARDNER, 321 NORTH CLARK STREET, SUITE 2800, CHICAGO, IL, 60610-4764, US

(73) Assignee: Gilman Engineering & Manufacturing Co., LLC

(21) Appl. No.: 10/668,821

(22) Filed: Sep. 23, 2003

(51) Int. Cl. B23P 11/00; B21D 39/03

(52) U.S. Cl. 29/429

(57) ABSTRACT

The present invention relates to the assembly of the type of clutch plate referred to as “scrapless”. A method and system in accordance with the principals of the present invention assembles clutch plate assemblies in a more efficient and robust manner. A method and system in accordance with the principals of the present invention provides for a segmented tooling assembly that can be both linear and circular.

### FIELD OF THE INVENTION

The present invention relates to the assembly of the type of clutch plate referred to as “scrapless”.

### BACKGROUND OF THE INVENTION

Prior art clutch plates use a flat ring of a fabric-like clutch material bonded to one or both sides of a metal ring. This metal ring has a spline on its inside diameter to transfer the torque placed on the clutch. The ring of clutch material is cut from a strip of the material, leaving a certain amount of scrap to be disposed of. In contrast, the “scrapless” type of clutch uses trapezoidal shaped segments placed side-by-side to form a circular interrupted ring of the material.

A disadvantage of the prior art process is that many segments are required to assemble each clutch plate. In the prior art process, very low cycle times are required for each segment placement in order to achieve a reasonable assembly rate for the complete assembly. For example, if 32 segments are required on each side of each clutch plate, a total of 64 segment placements are required for each clutch plate. In order to process a very modest 200 clutch plates per hour, 12,800 segments must be placed into nests every hour giving a very short 0.28 seconds for each placement operation. This speed is attainable, but creates many challenges in the areas of machine troubleshooting, machine maintenance, and robustness of machine longevity, for example.

What would therefore be desirable would be a method and system to assemble clutch plate assemblies in a more efficient and robust manner.

### SUMMARY OF THE INVENTION

A method and system in accordance with the principals of the present invention assembles clutch plate assemblies in a more efficient and robust manner. A method and system in accordance with the principals of the present invention provides for a segmented tooling assembly that can be both linear and circular.

### BRIEF DESCRIPTION OF THE DRAWINGS

FIG. 1 depicts a segmented clutch material.

FIG. 2 depicts a segmented tooling assembly.

### DETAILED DESCRIPTION OF THE INVENTION

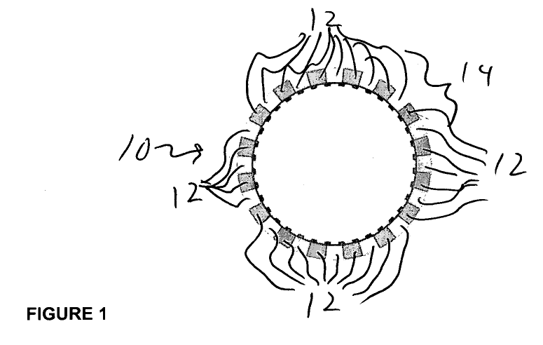

Referring to FIG. 1, segmented clutch material 10 is seen. The segmented clutch material 10 includes a plurality of segments 12 placed side-by-side to form a circular ring of material 14. The segments 12 are preferably trapezoidal shaped. The assembly process of the prior art calls for placing a single segment into one of a series of nest machined into a rotating ring. After each segment is placed (or pushed) into its nest the ring of nests is rotated so that the next segment may be placed into a nest. This is the process that results in many segments being required to assemble each clutch plate thus requiring very low cycle times for each segment placement in order to achieve a reasonable assembly rate for the complete assembly.

In accordance with the principles of the present invention, a pick-up head assembly is provided (not seen). The pick-up head assembly includes a pick-up device on each segment. In an embodiment, the pick-up device comprises a vacuum cup. In accordance with the principles of the present invention, the pick-up head assembly is segmented in such a way that it can be configured in a straight line to pick up the required number of segments and then configured in a circle to place the segments in a circular configuration.

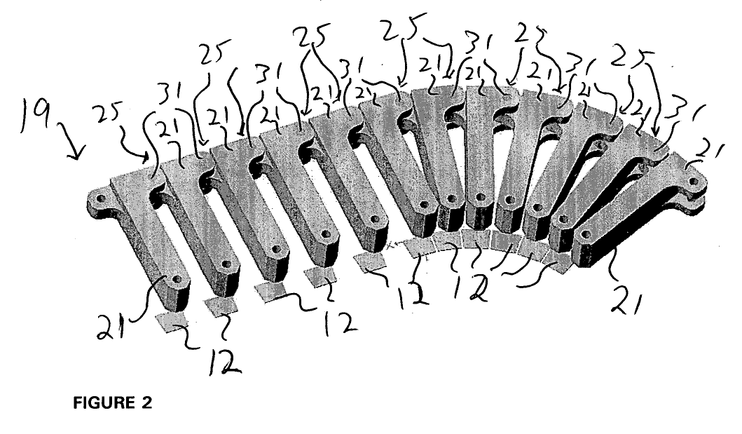

Referring to FIG. 2, a segmented tooling assembly 19 is seen. The segmented tooling assembly 19 includes a plurality segments tools 21. Each of the segment tools 21 is joined at a pivot point 25 that comprises a pin assembly 31. Numerous methods of changing the configuration of the tooling from a straight line into a circular configuration are within the scope of the present invention. In one embodiment, the clutch assembly includes a track that has both a straight portion and a circular portion for the segment to travel. By driving the segments from the straight section to the circular section the configuration is changed.

In another embodiment, the clutch assembly includes a barrel to which one end of the segmented tooling assembly is attached, the barrel rotates to wrap the segmented tooling assembly around the barrel in a circular fashion. In another embodiment, the clutch assembly includes a barrel to which the center of the segmented tooling assembly is attached, and two arms or links to which the two ends of the segmented tooling assembly are attached to wrap and unwrap the segmented tooling assembly around the barrel.

While the invention has been described with specific embodiments, other alternatives, modifications and variations will be apparent to those skilled in the art. Accordingly, all such alternatives, modifications and variations are intended to be included within the spirit and scope of the appended claims.

1. A method for assembling clutch plates comprising:
placing a plurality of segments side-by-side;
picking-up a required number of segments in a straight line; and
reconfiguring the segments in a circular configuration.

2. The method for assembling clutch plates of claim 1 further including placing a plurality of trapezoidal segments side-by-side.

3. The method for assembling clutch plates of claim 1 further wherein the step of picking-up a required number of segments in a straight line comprises picking-up each segment with a pick-up device.

4. The method for assembling clutch plates of claim 3 further wherein the step of picking-up a required number of segments in a straight line comprises picking-up each segment with a vacuum cup.

5. The method of claim 1 further including forcing the segment to travel along a track that has both a straight portion and a circular portion.

6. The method of claim 1 further including attaching one end of a segmented tooling assembly to a barrel which rotates to wrap the segmented tooling assembly around the barrel in a circular fashion.

7. The method of claim 6 further including further rotating the barrel to unwrap a segmented tooling assembly forcing the segments into a straight track.

8. The method of claim 1 further including attaching the center of a segmented tooling assembly to a barrel, attaching the two ends of the segmented tooling assembly to two arms to wrap the segmented tooling assembly around the barrel.

9. The method of claim 8 further including the two arms unwrapping the segmented tooling assembly from around the barrel.

10. The method of claim 1 further including attaching the center of a segmented tooling assembly to a barrel, and attaching the two ends of the segmented tooling assembly to two links to wrap the segmented tooling assembly around the barrel.

11. The method of claim 10 further including the two links unwrapping the segmented tooling assembly from around the barrel.

12. A clutch assembly comprising:
a plurality of segments placed side-by-side;
a pick-up head segmented such that the pick-up head can be configured in a straight line to pick up a required number of segments; and
the pick-up head further being configurable in a circle to place the segments in a circular configuration.

13. The clutch assembly of claim 12 further wherein the segments are trapezoidal shaped.

14. The clutch assembly of claim 12 further wherein the pick-up head comprises a pick-up device on each segment.

15. The clutch assembly of claim 14 further wherein the pick-up device comprises a vacuum cup.

16. The clutch assembly of claim 12 further including a track that has both a straight portion and a circular portion for the segment to travel.

17. The clutch assembly of claim 12 further including a barrel to which one end of a segmented tooling assembly is attached, the barrel rotating to wrap the segmented tooling assembly around the barrel in a circular fashion.

18. The clutch assembly of claim 17 further wherein the barrel is further rotated to unwrap the segmented tooling assembly from around the barrel.

19. The clutch assembly of claim 12 further including a barrel to which the center of a segmented tooling assembly is attached, and two arms to which the two ends of the segmented tooling assembly are attached to wrap the segmented tooling assembly around the barrel.

20. The clutch assembly of claim 1 9 further wherein the two arms to which the two ends of the segmented tooling assembly are attached unwrap the segmented tooling assembly from around the barrel.

21. The clutch assembly of claim 12 further including a barrel to which the center of a segmented tooling assembly is attached, and two links to which the two ends of the segmented tooling assembly are attached to wrap the segmented tooling assembly around the barrel.

22. The clutch assembly of claim 21 further wherein the two links to which the two ends of the segmented tooling assembly are attached unwrap the segmented tooling assembly from around the barrel.
